(19) United States
(12) Patent Application Publication
(10) Pub. No.: US 2013/0060890 A1
(43) Pub. Date: Mar. 7, 2013

(54) APPARATUS AND METHOD FOR PROVIDING APPLICATION EXECUTION USING A CLOUD SYSTEM

(71) Applicants: Se Hyun LEE, Seoul (KR); Bo Sun KIM, Seoul (KR); Soo Young HUH, Seoul (KR)

(72) Inventors: Se Hyun LEE, Seoul (KR); Bo Sun KIM, Seoul (KR); Soo Young HUH, Seoul (KR)

(73) Assignee: PANTECH CO., LTD., Seoul (KR)

(21) Appl. No.: 13/466,655

(22) Filed: May 8, 2012

(30) Foreign Application Priority Data
Sep. 7, 2011 (KR) 10-2011-0090550

(51) Int. Cl. G06F 12/16; G06F 15/16

(52) U.S. Cl. 709/217

(57) ABSTRACT

A terminal may backup data in a cloud server. The cloud server may generate a virtual device to perform substantially the same operations as the terminal, and may install an application in the virtual device if the application is determined to be unreliable by the terminal. The cloud server performs a reliability evaluation of the unreliable application and transmits the results of the reliability evaluation to the terminal. In addition, the terminal may store backup data in the cloud server. If the terminal malfunctions, the terminal may be restored by receiving the stored backup data from the cloud server. The terminal may remotely execute an application installed in the virtual device.

### CROSS-REFERENCE TO RELATED APPLICATION

This application claims priority from and the benefit of Korean Patent Application No. 10-2011-0090550, filed on Sep. 7, 2011, which is hereby incorporated by reference for all purposes as if fully set forth herein. This application is related to U.S. patent application Ser. No. 13/341,139, filed on Dec. 30, 2011, having attorney docket number P4627US00 which claims priority from and the benefit of Korean Patent Application No. 10-2011-0085008, filed on Aug. 25, 2011.

### BACKGROUND OF THE INVENTION

1. Field

The present disclosure relates to an apparatus and method for providing application execution to a terminal by backing up the terminal in a cloud server, creating a virtual device that is configured to perform substantially the same operation as the terminal, and executing a desired application (app) using the virtual device in the cloud server.

2. Discussion of the Background

As technology has developed and the Internet has been introduced to portable terminals, the scope of applications available for portable terminals has expanded from a simple telephone call, to managing a schedule, taking photographs through a digital camera, viewing satellite broadcasts, playing games, web surfing through the Internet, connecting to a wireless device through Bluetooth, listening to music, accessing an e-mail service, and the like.

In addition to an application program from a manufacturer, varied application programs may be installed by a user in portable terminals. It is difficult to determine whether the malicious code or a virus is included in an application program before the installing the program. Therefore, an application program with a malicious code or virus may be installed in the portable terminal (herein after “terminal”).

### SUMMARY

Exemplary embodiments of the present invention provide an apparatus and method for providing application execution using a cloud server, and restoring a terminal using stored backup data if the terminal malfunctions.

Exemplary embodiments of the present invention also provide a terminal to transmit, as backup data, data stored in a memory unit of the terminal to a cloud server, the cloud server to generate a virtual device configured to perform substantially the same operations as the terminal, and to perform a reliability evaluation of an application program to be installed in the terminal.

Additional features of the invention will be set forth in the description which follows, and in part will be apparent from the description, or may be learned by practice of the invention.

An exemplary embodiment of the present invention discloses a system to perform a reliability evaluation, including: a terminal to generate backup data corresponding to data stored in the terminal, and to transmit the backup data via a network; and a cloud server to receive the backup data, to generate a virtual device corresponding to the backup data, and to perform a reliability evaluation of an application using the virtual device, wherein the cloud server performs the reliability evaluation of the application in the virtual device in response to a request from the terminal and transmits the reliability evaluation result to the terminal.

An exemplary embodiment of the present invention also discloses a terminal, including: a backup processing unit to generate backup data corresponding to data stored in the terminal; an application downloader to download an application; a memory unit to store an application; a reliability evaluator to determine a reliability of the application; a communication unit to transmit the backup data; an application installer to install the application in the memory unit in response to a reliability evaluation result; and a virtual interface to alter a code of the application to generate an operation call message if the reliability evaluation result indicates that the application is unreliable.

An exemplary embodiment of the present invention also discloses a cloud server, including: a backup processing unit to receive backup data from a terminal; a virtual device processing unit to generate a virtual device corresponding to the backup data; a reliability evaluator to evaluate reliability of an application in response to a request from the terminal; and a virtual interface to receive an operation call and to execute the application in the virtual device.

An exemplary embodiment of the present invention also discloses a method for executing an application in a virtual device, including: generating the virtual device in a cloud server; receiving an operation call to the virtual device in the cloud server, the operation call corresponding to an application; executing the operation included in the operation call in the virtual device; determining if an execution result of the operation is generated; and if the execution result is generated, transmitting the execution result to the terminal.

An exemplary embodiment of the present invention also discloses a method for executing an application in a terminal, including: generating backup data corresponding to data stored in the terminal; transmitting the backup data to a cloud server, the backup data for generating a virtual device in the cloud server; downloading an application in the terminal; evaluating reliability of the application in the terminal; if the application is considered reliable, executing the application; and if the application is not considered reliable: storing the application in an unreliable application region of the terminal; altering a code of the application to generate an operation call to the virtual device; requesting a reliability evaluation of the application from a cloud server; receiving a result of the reliability evaluation; and if the reliability evaluation determines the application is reliable, executing the application in the terminal.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a diagram illustrating a system to provide a reliability evaluation according to an exemplary embodiment of the present invention.

FIG. 2 is a diagram illustrating a terminal according to an exemplary embodiment of the present invention.

FIG. 3 is a diagram illustrating a cloud server according to an exemplary embodiment of the present invention.

FIG. 4 is a diagram illustrating a reliability database (DB) according to an exemplary embodiment of the present invention.

FIG. 5 is a flowchart illustrating a method for installing a new application (app) in a terminal according to an exemplary embodiment of the present invention.

FIG. 6 is a flowchart illustrating a method for remotely executing an app according to an exemplary embodiment of the present invention.

FIG. 7 is a flowchart illustrating a method for remotely executing an app according to an exemplary embodiment of the present invention.

FIG. 8 is a flowchart illustrating a method for generating a virtual device according to an exemplary embodiment of the present invention.

FIG. 9 is a diagram illustrating a method for executing a reliable app and an unreliable app according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element is referred to as being “connected to” another element, it can be directly connected to the other element, or intervening elements may be present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Throughout the specifications, an application program, an application, and a firmware may be referred to as an “app.”

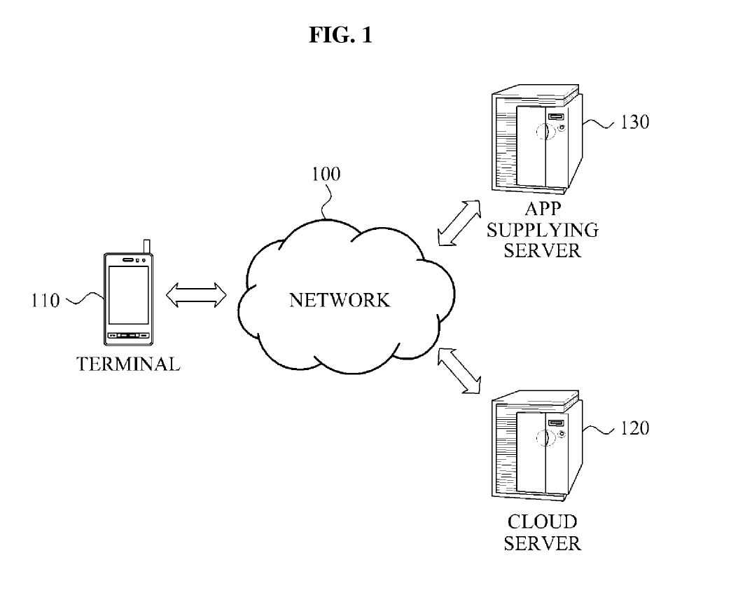

FIG. 1 is a diagram illustrating a system to provide a reliability evaluation according to an exemplary embodiment of the present invention.

Referring to FIG. 1, the system to provide a reliability evaluation may include a terminal 110, a cloud server 120, and an app supplying server 130.

The terminal 110 may generate all or a portion of data included in the terminal 110 as backup data, and may transmit the backup data to the cloud server 120 over a network 100. The terminal 110 may be any terminal capable of data communication, such as a mobile phone, a tablet computer, a laptop computer, a desktop computer, etc.

If problems occur in the terminal 110, for example, a system error, a virus, and the like, the terminal 110 may be restored using the backup data transmitted to and stored in the cloud server 120.

If an app for which reliability information does not exist is to be executed in the terminal 110, the app may be executed through the cloud server 120 until the app is verified to be a reliable app.

The cloud server 120 may generate a virtual device that is capable of and configured to perform substantially the same operations as the terminal 110 using the backup data received from the terminal 110. The cloud server 120 may enable an operation of an operation call message to be processed in the virtual device if the operation call message is received for the app, and may transmit an execution result to the terminal 110.

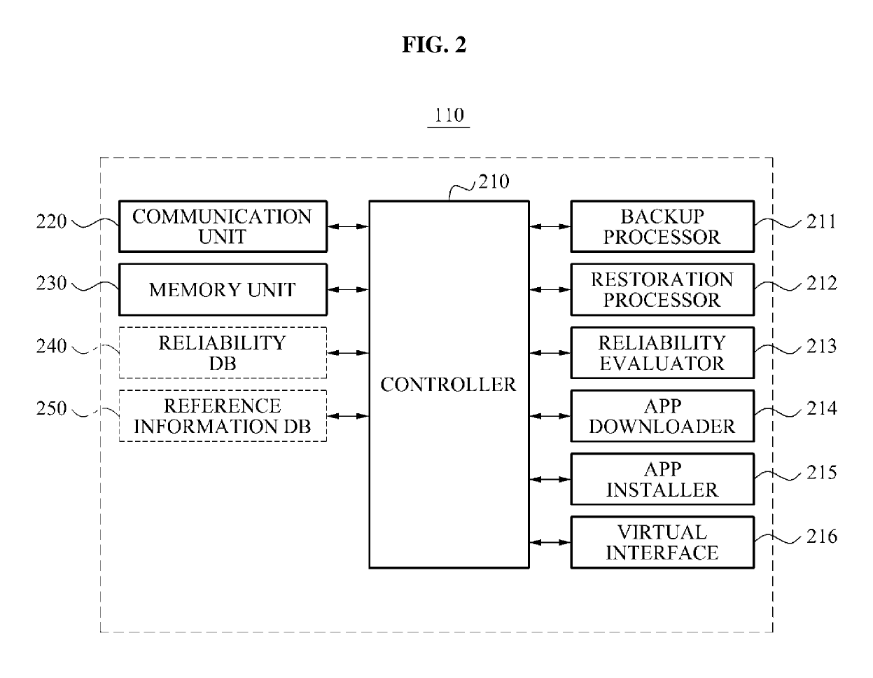

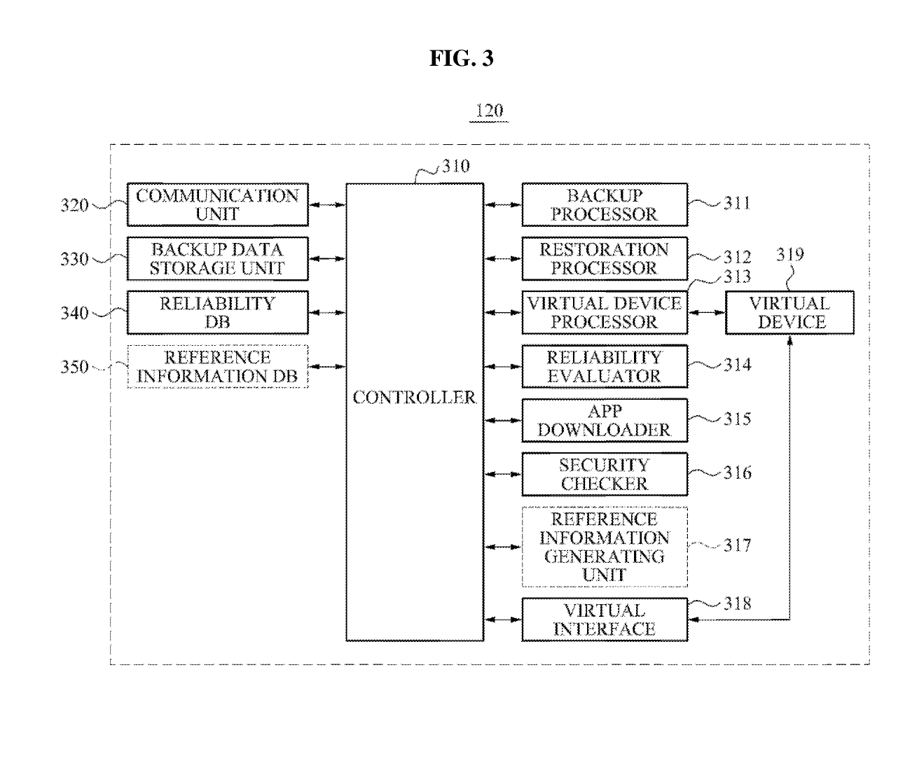

The terminal 110 and the cloud server 120 will be described in more detail with reference to FIG. 2 and FIG. 3.

FIG. 2 is a diagram illustrating a terminal according to an exemplary embodiment of the present invention.

Referring to FIG. 2, the terminal 110 may include a controller 210, a backup processor 211, a restoration processor 212, a reliability evaluator 213, an app downloader 214, an app installer 215, a virtual interface 216, a communication unit 220, and a memory unit 230. The terminal 110 may also include at least one of a reliability DB 240 and a reference information DB 250.

The communication unit 220 may transmit data to and receive data from the cloud server 120 or the app supplying server 130 via the network 100. The network 100 may be a wired or wireless network. The communication unit 220 may transmit data to and receive data based on a wireless communication scheme, for example, a frequency division multiple access (FDMA)-based communication scheme, a time division multiple access (TDMA)-based communication scheme, a space-division multiple access (SDMA)-based communication scheme, a code division multiple access (CDMA)-based communication scheme, a wideband code division multiple access (WCDMA)-based communication scheme, an orthogonal frequency division multiplexing (OFDM)-based communication scheme, a wireless fidelity (Wi-Fi)-based communication scheme, a wireless broadband (Wibro®)-based communication scheme, a Bluetooth-based communication scheme, an infrared light-based communication scheme. The communication unit 220 may transmit and receive a wireless signal of data input and output via an antenna. For example, in the case of the transmission of data, the communication unit 220 may perform channel coding and spreading with respect to data to be transmitted, and may perform radio frequency (RF) processing with respect to the data, and may transmit the RF processed data. In the case of the reception of data, the communication unit 220 may convert the received RF signal to a baseband signal, and may perform de-spreading and channel decoding with respect to the data to restore the data. When an element of the terminal 110 transmits data to and receives data from the cloud server 120 or the app supplying server 130, the data transmission and reception by the cloud server 120 or the app supplying server 130 is performed through the a communication unit similar to communication unit 220 and thus, descriptions of the equivalent communication unit in the cloud server 120 and the application supply server 130 will be omitted.

The memory unit 230 may store system data associated with an operating system (OS) to control general operations of the terminal 110, an installed app, update information of the installed app, and user data, for example, a telephone number, a short message service (SMS) message, a multimedia message service (MMS) message, a compressed image file, a moving picture, and the like. The memory unit 230 may store backup data generated from the backup processor 211 or backup data received from the cloud server 120.

The memory unit 230 may include an unreliable app region. The unreliable app region may correspond to a region in which an unreliable app, or an app for which reliability information is not determined or known, may be installed. The remaining app regions, excluding the unreliable app region, of the memory unit 230 may correspond to a reliable app region.

The reliability DB 240 may store information associated with the reliability of each app of the terminal 110. Information associated with the reliability of each app stored in the reliability DB 240, may be provided from the cloud server 120 or an additional server that evaluates reliability of the app, which may or may not be the same server as the cloud server 120.

The reference information DB 250 may store reference information, i.e., a criterion for evaluation of a reliability of an app. The reference information stored in the reference information DB 250 may be provided from the cloud server 120 or an additional server that generates reference information. The reference information may include at least one of a reliable category, a reliable producer, a reliable sales server, a reliable reference release date, and a reliable permission.

For example, if the reference information includes a sales server P, apps that are being sold by the sales server P may be determined to be reliable. If the reference information is a producer A, apps produced by the producer A may be determined to be reliable. If the reference information is a combination of the sales server P and the producer A, apps that are produced by A and being sold by the sales server P may be determined to be reliable.

The backup processor 211 may generate all or a portion of data stored in the memory unit 230 as backup data, and may transmit the backup data to the cloud server 120. The backup data may include a time stamp indicating a generation time of the backup data.

The backup processor 211 may generate backup data including data to generate, in the cloud server 120, a virtual device that is configured to perform and capable of performing substantially the same operations as the terminal 110. The data to generate the virtual device may include system data, an installed app, update information associated with the installed app, and may additionally include user data, for example, a phone number, an SMS message, a compressed image file, a moving picture, and the like.

When the backup processor 211 generates the backup data, the backup processor 211 may read data stored in the memory unit 230 based on a block unit, and may compress the data to generate the backup data.

The backup processor 211 may generate updated data, and may transmit the updated data when the occurrence of an update event is detected. The updated data may include a time stamp indicating a generation time of the updated data.

The backup processor 211 may generate the updated data by compressing changed or added data, or may generate the updated data by compressing a changed block of the memory unit 230 based on a block unit. If the updated data is generated based on the block unit, changed data and unchanged data may be included in a single block. Since the unchanged data is also compressed along with the changed data resources may be wasted. However, by using the cloud server 120 to store backup data for the terminal, the backup data may be managed using the updated data or separately from the updated data.

The backup processor 211 may detect the occurrence of the update event when at least one of the following occurs: an instance where content of data stored in the memory unit 230 is changed or added, an instance where a number of times that content of data stored in the memory unit 230 is changed or added is greater than or equal to a reference number, an instance where an amount of data, stored in the memory unit 230, of which content is changed or added is greater than a reference value, an instance where a block of the memory unit 230 is changed, an instance where a number of times that the block of the memory unit 230 is changed is greater than or equal to a reference value, an instance where a number of changed blocks among blocks in the memory unit 230 is greater than or equal to a reference value, an instance where an update interval exceeds a reference update interval, and an instance where a request from a user is detected.

When a system error occurs or a virus is detected in the terminal 110 or when a check result indicating that an app is vulnerable to a security breach is received from the cloud server 120, in response to a request from the user, the restoration processor 212 may request backup data from the cloud server 120 and may receive the backup data from the cloud server 120 to restore the terminal 110. The received backup data may be the most recent backup data including data from the last update. The restoration processor 212 may receive the backup data stored at a reference time and may restore the terminal 110 to its condition at the reference time.

The reliability evaluator 213 may evaluate the reliability of a desired app. The reliability evaluator 213 may evaluate a reliability based on various schemes. Examples of the reliability evaluator 213 evaluating reliability are provided below.

The reliability evaluator 213 may request evaluation of a reliability of an app from the cloud server 120, and may receive an evaluation result associated with the reliability of the app from the cloud server 120 to evaluate the reliability of the app.

The reliability evaluator 213 may search for an app in the reliability DB 240 to evaluate the reliability of the app.

The reliability evaluator 213 may receive basic information associated with an app from the app supplying server 130, and may determine whether the basic information satisfies a criterion stored in the reference information DB 250 to evaluate the reliability of the app.

The basic information may include a category of an app, a producer of an app, a sales server of an app, a release date of an app, a permission of an app, and the like. The reference information may be configured to include at least one of a reliable category, a reliable producer, a reliable sales server, a reliable reference release date, and a reliable permission. Examples of reference information considered in determining the reliability of an app are described as follows. The reference information may be apps produced by a reference producer considered to be reliable. Apps produced by a reference producer before a reference release date and being sold by a reference sale server may be considered reliable. Apps in a reference category and being sold by a reference sales server may also be considered reliable. Apps having a reference permission among apps being sold by a reference sales server may be considered reliable.

If the reference information is a sales server P, apps being sold by the sales server P may be considered reliable. If the reference information is a producer A, apps produced by the producer A may be considered reliable. If the reference information is a combination of the sales server P and the producer A, apps generated by the producer A and being sold by the sales server P may be considered reliable.

The app downloader 214 may download an app from the app supplying server 130. The app downloader 214 may download the app after receiving a request for installation of the app from the user or after a reliability of the app has been determined.

The app installer 215 may install the app downloaded by the app downloader 214 in an unreliable app region if the reliability of the app is less than or equal to a reference value, or if the reliability of an app is not known or determined. The app installer 215 may manage the app installed in the unreliable app region by storing the app in an unreliable app list.

The app installer 215 may install the app downloaded by the app downloader 214 in a reliable app region of the memory unit 230 if the reliability of the app is greater than the reference value.

In response to a request for execution of an app installed in the unreliable app region, the virtual interface 216 may call an operation of the virtual device managed by the cloud server 120. The virtual interface 216 may call the virtual device 219 managed by the cloud server 120 by changing a code of the app to execute the call. The virtual interface 216 may transmit an operation call message to the cloud server 120 based on the changed code of the app. If an execution result associated with the operation call message is received from the cloud server 120, the virtual interface 216 may display the execution result.

If terminal variable information, i.e., information from the terminal 110 that may be required to process the operation included in the operation call message, the virtual interface 216 may collect the terminal variable information to process the operation included in the operation call message. The virtual interface 216 may transmit, to the cloud server 120, the collected terminal variable information by including the collected terminal variable information in the operation call message. The terminal variable information may include at least one of location information of a terminal, information associated with a base station accessed by a terminal, information associated with a sharer, such as an access point or a router, accessed by a terminal, orientation information of a terminal, information associated with a measurement measured by a sensor included in a terminal, etc.

For example, if an app used to retrieve restaurants located near the terminal 110 is virtually processed, the virtual interface 216 may transmit to the cloud server 120, as the terminal variable information, location information of the terminal 110 by including the location information in an operation call message including an operation to be used for retrieving restaurants.

In other words, the virtual interface 216 may alter an existing code corresponding to an operation call of an app installed in an unreliable app region to call an operation in an OS of the virtual device of the cloud server 120, as opposed to calling an operation in an OS of the terminal 110. A method of remotely controlling the virtual device by the virtual interface 216 may be embodied by a remote method invocation (RMI) scheme, and the like. Here, the RMI scheme may enable two different devices to be compatible with each other to remotely provide an operation call.

The app installer 215 may remove the app from the memory unit 230 if a check result indicating that the app is vulnerable to a security breach is received from the cloud server 120.

The app installer 215 may move the app installed in the unreliable app of the memory unit 210 to a reliable app region of the memory unit 230 to execute the app in the terminal 110 if the app is determined to be reliable.

The app may be determined to be a reliable app if at least one of following occurrences takes place after the app is installed in the unreliable app region of the memory unit 230: a check result indicating that the app is vulnerable to a security breach is not received from the cloud server 120 within a reference time, a check result indicating that the app is vulnerable is not received from the cloud server 120 while an execution instruction associated with the app is performed a reference number of times, and a check result indicating that the app is secure is received from the cloud server 120.

The controller 210 may control overall operations of the terminal 110. The controller 210 may perform operations of the backup processor 211, the restoration processor 212, the reliability evaluator 213, the app downloader 214, the app installer 215, and the virtual interface 216. The controller 210, the backup processor 211, the restoration processor 212, the reliability evaluator 213, the app downloader 214, the app installer 215, and the virtual interface 216 are depicted as different units to describe the respective operations of each unit. However, the controller 210 may include at least one processor configured to perform the operation or a portion of the operation of each of the backup processor 211, the restoration processor 212, the reliability evaluator 213, the app downloader 214, the app installer 215, and the virtual interface 216.

FIG. 3 is a diagram illustrating a cloud server according to an exemplary embodiment of the present invention.

Referring to FIG. 3, the cloud server 120 may include a controller 310, a backup processor 311, a restoration processor 312, a virtual device processor 313, a reliability evaluator 314, an app downloader 315, a security checker 316, a virtual interface 318, a communication unit 320, a backup data storage unit 330, and a reliability DB 340. The cloud server 120 may additionally include a reference information generating unit 317 and a reference information DB 350.

The communication unit 320 may transmit or receive data from the terminal 110 or the app supplying server 130 via a network. The communication unit 320 may transfer data in a manner substantially similar to communication unit 220. The communication unit 320 may be substantially similar to the communication unit 220 of the terminal 110 and thus description of the communication 320 is omitted for brevity.

The backup data storage unit 330 may store updated data and backup data received from the terminal 110. The backup data storage unit 330 may store a time stamp indicating a receipt time or a generation time of the backup data and the updated data, along with the backup data and the updated data. In other words, the backup data storage unit 330 may manage the backup data and the updated data based on a receipt time or a generation time.

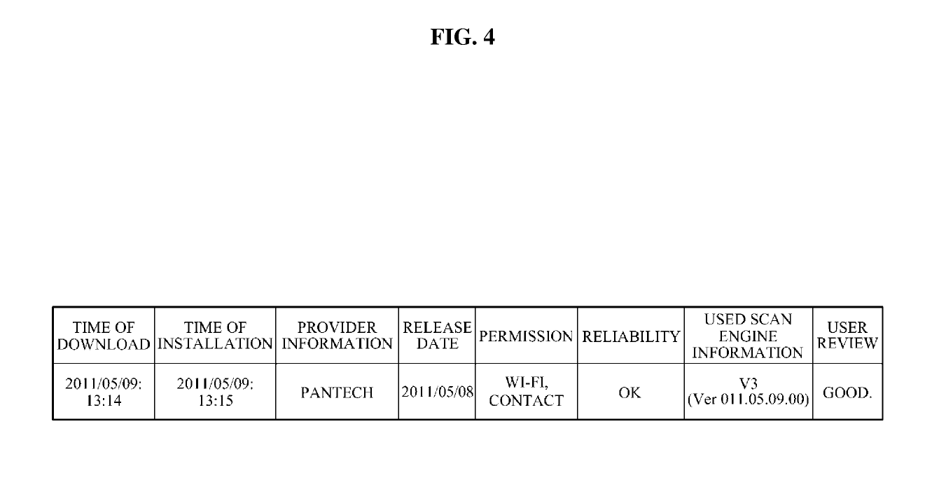

The reliability DB 340 may store information associated with a reliability of each app. The reliability DB 340 may be configured as shown in FIG. 4.

FIG. 4 is a diagram illustrating a reliability DB according to an exemplary embodiment of the present invention. The reliability DB of FIG. 4 will be described with reference to the reliability DB 340 of FIG. 3, but is not limited as such.

Referring to FIG. 4, the reliability DB 340 may include a time of download, a time of installation, provider information, a release date, a permission, a reliability status, used search engine information (i.e., information associated with a used virus scan engine), user review information, and the like.

Referring again to FIG. 3, the reference information DB 350 may store reference information, i.e., a criterion for evaluation of a reliability of an app. The reference information may include at least one of a reliable category, a reliable provider, a reliable sales server, a reliable reference release date, and a reliable permission.

The backup processor 311 may store backup data in the backup data storage unit 330 if the backup data generated based on all or a portion of data stored in the memory unit of the terminal 110 is received. The backup data may include data used to generate a virtual device that is configured to perform and capable of performing substantially the same operations as the terminal 110 if the cloud server 120 virtually processes an app. The data used to create the virtual device may include system data of the terminal 110, an installed app, and update information of the installed app, and may additionally include user data, for example, a phone number, an SMS message, a compressed image file, a moving picture, and the like.

If updated data is received from the terminal 110, the backup processor 311 may store the received updated data in the backup data storage unit 330. In this example, the backup processor 311 may manage the backup data and the updated data based on a time stamp of the backup data and a time stamp of the updated data, respectively.

If the backup data is requested by the terminal 110, the restoration processor 312 may retrieve the backup data of the terminal 110 from the backup data storage unit 330 and may transmit the retrieved backup data to the terminal 110. The transmitted backup data may be the most recent backup data including data from the last updated data. If backup data at a reference time is requested by the terminal 110, the restoration processor 312 may transmit the backup data at the reference time based on the time stamp of the backup data and the time stamp of the updated data stored in the backup data storage unit 330.

If a reliability evaluation of an app is requested by the terminal 110, the reliability evaluator 314 may evaluate the reliability of the app, and may provide an evaluation result to the terminal 110. The reliability evaluator 314 may evaluate the reliability of the app based on the schemes described below.

The reliability evaluator 314 may evaluate the reliability of the app by searching the reliability DB 340 for the requested application.

The reliability evaluator 314 may receive basic information associated with the app from the app supplying server 130, and may determine whether the basic information satisfies the reference information stored in the reference information DB 350 to evaluate the reliability of the app. The reference information may be a criterion for evaluation of the reliability of the app.

The app downloader 315 may download the app from the app supplying server 130 if a virtual process of the app is requested by the terminal 110.

The virtual device processor 313 may generate a virtual device 319 that is configured to perform and capable of performing substantially the same operations as the terminal 110, based on the backup data of the terminal 110. For example, the virtual device 319 may correspond to a virtual device that exists in the cloud server 120 and that uses a framework or an OS in the cloud server 120 to perform substantially the same operations as an operations performed based on a framework or an OS of the terminal 110. If the virtual device 319 is generated, the virtual device processor 313 may install, in the virtual device 319, the app downloaded by the app downloader 315. Thus, the virtual device processor 313 may install an app in the virtual device 319 of the cloud server 120, before installing the app in the terminal 110, to perform a virus check with respect to the app.

The security checker 316 may determine a security of the app installed in the virtual device 319, and transmit a check result to the terminal 110. The security checker 316 may determine whether the app includes a virus or a malicious code, whether the app collects user information, whether user information is leaked by the app, and the like.

The security checker 316 may store, in the reliability DB 340, the check result corresponding to reliability information associated with the app.

If the app installed in the virtual device 319 is determined to be a vulnerable app, i.e., an app vulnerable to a security breach, the virtual device processor 313 may restore the virtual device 319 to an operational state before the app was installed, based on the backup data and the updated data stored in the backup data storage unit 330 or the terminal 110.

Even if the app installed in the virtual device 319 is not determined to be an vulnerable app, the virtual device processor 313 may restore the virtual device 319 to the state before the app was installed, based on the backup data or the updated data stored in the backup data storage unit 330 or by receiving the backup data from the terminal 110 if the app is removed from the terminal 110.

The reference information generating unit 317 may generate reference information, i.e., a criterion for evaluating a reliability of an app, based on the reliability information stored in the reliability DB 340. The reference information generating unit 317 may store the reference information in the reference information DB 350, and may transmit the reference information to the terminal 110.

The reference information may include at least one of a reliable category, a reliable producer, a reliable sales server, a reliable reference release date, and a reliable permission. For example, if a number of apps previously produced by a producer A and currently being sold by a sales server P is greater than a reference number, such as 50, and if it is determined that all the apps previously produced by the producer A and currently being sold by the sales server P do not include viruses, the reference information generating unit 317 may generate, as reference information, an app generated by the producer A and being sold by the sales server P. Subsequently, if an app corresponds to the app generated by the producer A and being sold by the sales server P, the app may be determined to be reliable.

If an operation call message is received from the terminal 110, the virtual interface 318 may enable an operation included in the operation call message to be executed in the virtual device 319. The virtual interface 318 may transmit, to the terminal 110, an execution result of the virtual device 319 executed in response to the operation call message.

The virtual interface 318 may receive an operation call message that includes terminal variable information from the terminal 110. If the terminal virtual information is received in the operation call message, the virtual interface 318 may enable the operation call to be execute in the virtual interface 318 based on the terminal virtual information. The terminal virtual information may refer to at least one of location information of a terminal, information associated with a base station accessed by a terminal, information associated with a sharer accessed by a terminal, orientation information of a terminal, and information associated with a measurement measured by a sensor included in a terminal, etc.

If a reliability of an app installed in the terminal 110 is not determined, the virtual interface 318 may execute the app of the terminal 110 using the virtual device 319. In this example, the virtual interface 318 may remotely control the virtual device 319 based on an RMI scheme, and the like.

The controller 310 may control overall operations of the cloud server 120. The controller 310 may perform operations of the backup processor 311, the restoration processor 312, the virtual device processor 313, the reliability evaluator 314, the app downloader 315, the security checker 316, the reference information generating unit 317, and the virtual interface 318. The controller 310, the backup processor 311, the restoration processor 312, the virtual device processor 313, the reliability evaluator 314, the app downloader 315, the security checker 316, the reference information generating unit 317, and the virtual interface 318 are separately illustrated to describe the operations of each unit. However, the controller 310 may include at least one processor configured to perform respective the operation or a portion of the operation of each of the backup processor 311, the restoration processor 312, the virtual device processor 313, the reliability evaluator 314, the app downloader 315, the security checker 316, the reference information generating unit 317, and the virtual interface 318.

Hereinafter, methods using a cloud system will be described in more detail with reference to drawings. The following methods are described as if performed by the system shown in FIG. 1, but are not limited as such.

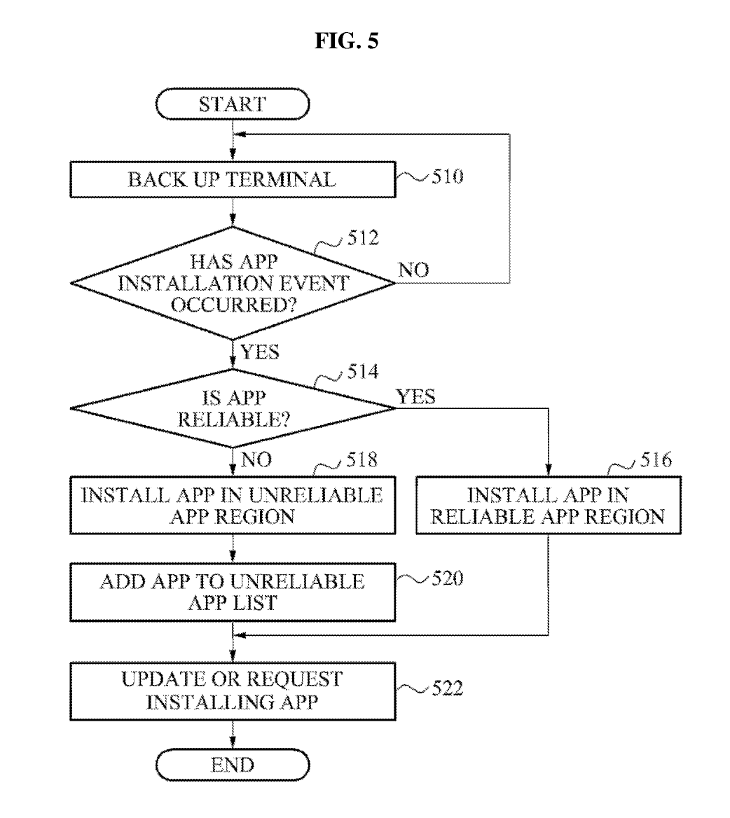

FIG. 5 is a flowchart illustrating a method for installing a new app in a terminal according to an exemplary embodiment of the present invention.

Referring to FIG. 5, in operation 510, the terminal 110 may generate backup data including data used to create a virtual device that is configured to perform and capable of performing, in a cloud server, substantially the same operations as the terminal 110, and may transmit the generated backup data to the cloud server 120.

In operation 512, the terminal detects the occurrence of an event to install an app. In operation 514, the terminal may evaluate a reliability of the app. The terminal may evaluate the reliability of the app by transmitting, to the cloud server 120, a message to request evaluation of the reliability of the app or by utilizing information stored in a reliability DB 240 or a reference information DB 250. The message to request evaluation of reliability may include basic information associated with the app, such as terminal virtual information.

If the app is determined to be reliable in operation 514, in operation 516, the terminal 110 may install the app in a reliable app region of the memory unit 230.

If the app is determined to be unreliable or if reliability is unknown in operation 514, in operation 518, the terminal 110 may install the app in an unreliable app region of the memory unit 230. The app may be downloaded from an app supplying server 130, and the download may be performed before or after operation 514.

In operation 520, the terminal 110 may add, to an unreliable app list, information associated with the app installed in the unreliable app region of the memory unit 230 in operation 518.

In operation 522, the terminal 110 may generate updated data indicating that an update occurred to transmit the updated data to the cloud server 120, or may transmit an app installation request message to request the cloud server 120 to install, in the virtual device 319 of the cloud server 120, the app installed in the terminal 110.

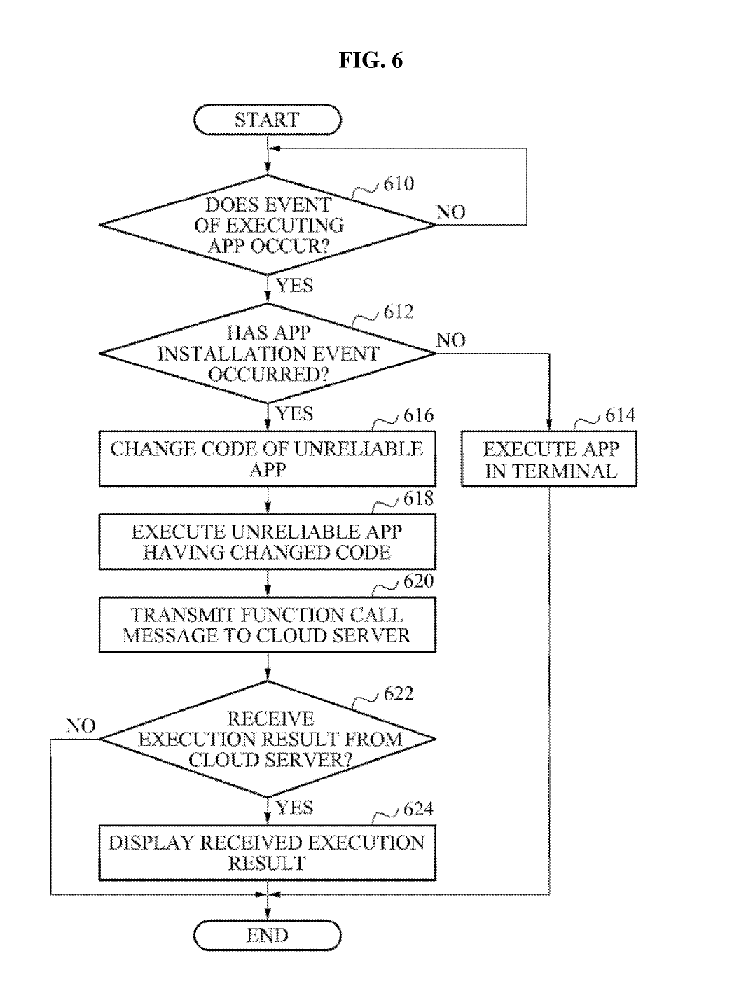

FIG. 6 is a flowchart illustrating a method for remotely executing an app according to an exemplary embodiment of the present invention.

Referring to FIG. 6, in operation 610, an app execution event is detected. In operation 612, the terminal 110 may determine whether the app is an unreliable app. The unreliability of the app may be determined by determining whether the app is installed in an unreliable app region of the memory unit 230 or by determining whether the app is stored in an unreliable app list.

If the app is determined to be reliable in operation 612, in operation 614, the terminal 110 may execute the installed app in the terminal.

If the app is determined to be unreliable in operation 612, in operation 616, the terminal 110 may change a code of the unreliable app to call an operation of a virtual device 319 managed by a cloud server 120 if the unreliable app is executed.

In operation 620, the terminal 110 may transmit, to the cloud server 120, an operation call message based on the changed code of the unreliable app. An operation call message to the cloud server 120 may be an RMI scheme. The RMI scheme may enable two different devices to be compatible with each other to remotely provide an operation call.

If terminal variable information is required to execute the operation included in the operation call, the terminal 110 may collect the terminal variable information, and may transmit, to the cloud server 120, the collected terminal variable information by including the collected terminal variable information in the operation call message in operation 620. The terminal variable information may include at least one of location information of the terminal 110, information associated with a base station accessed by the terminal 110, information associated with a sharer accessed by the terminal 110, orientation information of the terminal 110, and information associated with a measurement measured by a sensor included in the terminal 110.

In operation 622, the terminal 110 may determine whether an execution result is received from the cloud server 120.

If the execution result is received from the cloud server in operation 622, in operation 624, the terminal 110 may display the received execution result.

If the execution result is not received from the cloud server 120 in operation 622, the method ends.

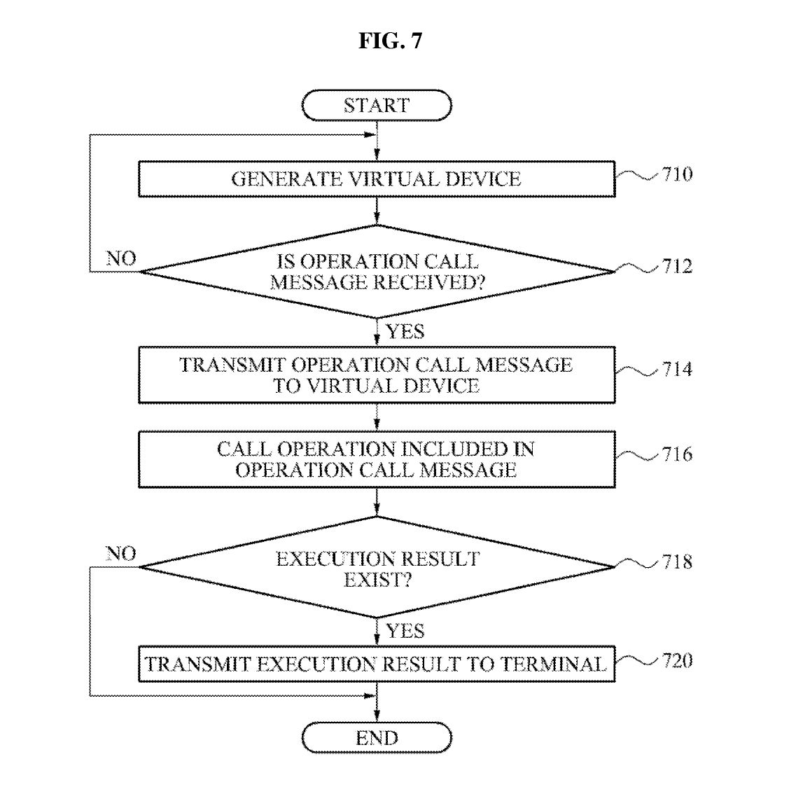

FIG. 7 is a flowchart illustrating a method for remotely executing an app according to an exemplary embodiment of the present invention.

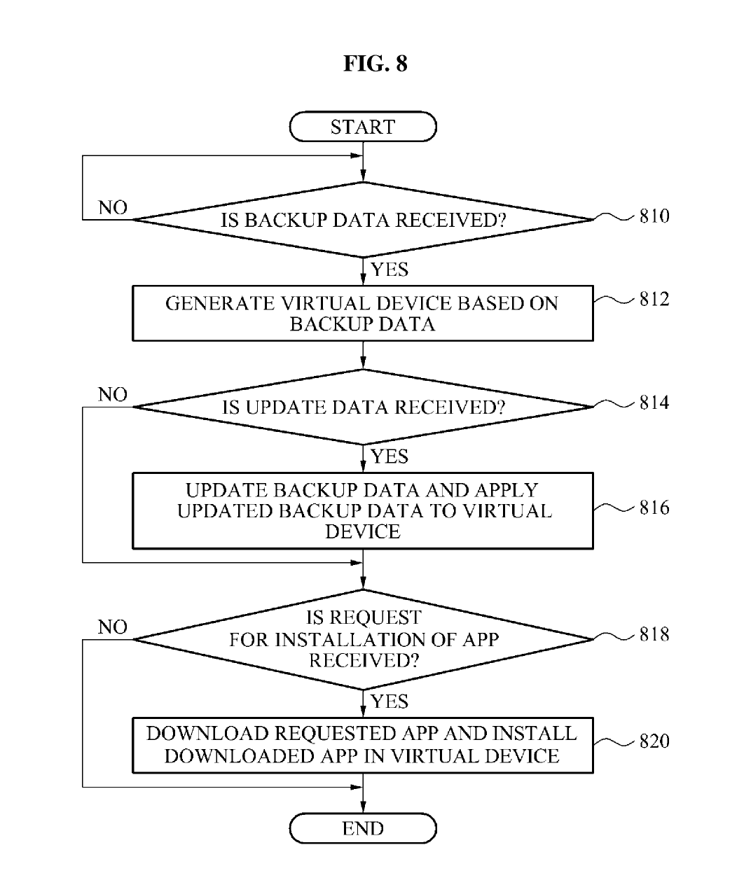

Referring to FIG. 7, in operation 710, the cloud server 120 may generate a virtual device 319 in which an unreliable app is to be executed. The virtual device will be described in more detail with reference to FIG. 8.

In operation 712, the cloud server 120 may determine if an operation call message is received.

If the operation call message is received in operation 712, in operation 714, the cloud server 120 may transmit the operation call message to a virtual device 319 corresponding to the terminal 110.

In operation 716, the cloud server 120 may call an operation included in the operation call message through the virtual device 319.

In operation 718, the cloud server 120 may determine whether an execution result to be output exists, as a result of the call of the operation.

If the execution result exists in operation 718, in operation 720, the cloud server 120 may transmit the execution result to the terminal 110.

FIG. 8 is a flowchart illustrating a method for generating a virtual device according to an exemplary embodiment of the present invention.

Referring to FIG. 8, in operation 810, the cloud server 120 receives backup data from the terminal 110. In operation 812, the cloud server 120 may generate, based on the received backup data, the virtual device 319 that is configured to perform and capable of performing substantially the same operations as the terminal 110.

If the cloud server receives updated data from the terminal in operation 814, in operation 816, the cloud server 120 may update the backup data using the received updated data and may apply the updated backup data to the generated virtual device 319.

If the cloud server 120 receives a request for installation of an app from the terminal 110 in operation 818, the cloud server 120 may download the requested app from an app supplying server 130 to install the downloaded app in the virtual device 319.

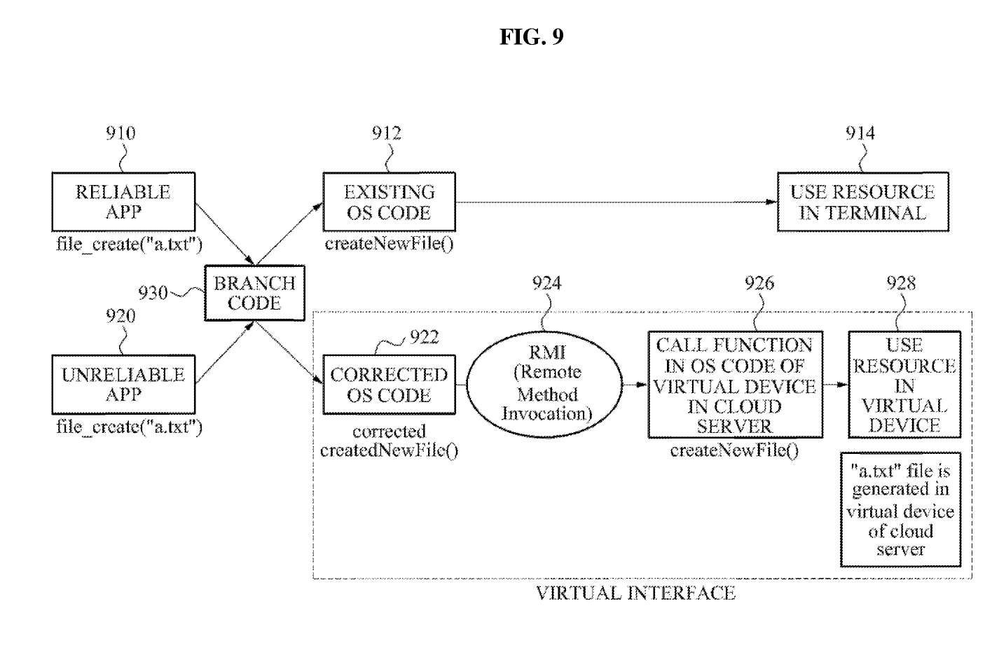

FIG. 9 is a diagram illustrating a method for executing a reliable app and an unreliable app according to an exemplary embodiment of the present invention.

Referring to FIG. 9, the method for executing a reliable app 910 and a process of executing the unreliable app 920 may be different from each other.

In operation 930, it is determined if the app 910 and the app 920 are reliable. If the app is the reliable app 910, in operation 912, the existing OS code of the app is maintained. In operation 914, the existing OS code is executed in the terminal 110.

If the app is the unreliable app 920, the code of the app may be changed to a corrected OS code in operation 922.

In operation 926, the corrected OS code 922 may call, based on an RMI scheme 924 and the like, an operation included in an OS code of the virtual device 319 included in the cloud server 120, as opposed to calling an operation in the terminal 110. If the operation in the OS code of the virtual device is called in operation 926, the called operation may be executed based on a resource in the virtual device 319 in operation 928.

For example, when the downloaded app calls an operation that generates “a txt” file, for example, a file_create(“a.txt”) operation, and the downloaded app is determined to a call createNewFile( ) operation corresponding to an OS operation included in the file_create(“a.txt”) operation, an unreliable app may correct an existing OS code so as to call a corrected createNewFile( ) operation. The corrected createNewFile( ) operation may call a createNewFile( ) operation included in an OS of the virtual device 319 based on the RMI scheme and the like. The createNewFile( ) operation included in the virtual device may include substantially the same content and substantially the same operation as the existing OS operation of the terminal, and since the createNewFile( ) operation included in the virtual device 319 is executed in the virtual device 319, “a txt” file may be generated in the virtual device 319, as opposed to being generated in the terminal 110.

According to exemplary embodiments described above, a cloud system may back up a terminal in a cloud server and execute an execution instruction for an app through the cloud server. By checking the app before installing it in the terminal, the cloud server may prevent or reduce the risk of virus damage that may occur if an app including a virus is installed in the terminal. Similarly, if the terminal experiences virus damage due to installing an app having a virus, the terminal's memory may be restored from the backup data that is stored on the cloud server.

The exemplary embodiments according to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of non-transitory computer-readable media include magnetic media such as hard disks, floppy disks, and magnetic tape; optical media such as CD ROM discs and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A system to perform a reliability evaluation, comprising:
a terminal to generate backup data corresponding to data stored in the terminal, and to transmit the backup data via a network; and
a cloud server to receive the backup data, to generate a virtual device corresponding to the backup data, and to perform a reliability evaluation of an application using the virtual device,
wherein the cloud server performs the reliability evaluation of the application in the virtual device in response to a request from the terminal and transmits the reliability evaluation result to the terminal.

2. The system of claim 1, wherein the cloud server determines the application to be unreliable if a reliability result of the application is less than or equal to a reference value.

3. The system of claim 1, wherein the terminal alters a code of an unreliable application to operation call the virtual device to execute the unreliable application.

4. A terminal, comprising:
a backup processing unit to generate backup data corresponding to data stored in the terminal;
an application downloader to download an application;
a memory unit to store an application;
a reliability evaluator to determine a reliability of the application;
a communication unit to transmit the backup data;
an application installer to install the application in the memory unit in response to a reliability evaluation result; and
a virtual interface to alter a code of the application to generate an operation call message if the reliability evaluation result indicates that the application is unreliable.

5. The terminal of claim 4, wherein the application installer installs the application in an unreliable application region of the memory unit if the reliability evaluation result indicates that the application is unreliable.

6. The terminal of claim 4, further comprising:
a reliability database to store reliability information for the application; and
a reference information database to store reference information corresponding to the application.

7. The terminal of claim 6, wherein the reference information comprises at least one of a reliable category, a reliable producer, a reliable sales server, a reliable reference release date, and a reliable permission.

8. The terminal of claim 4, wherein the reliability evaluator determines the reliability of the application by requesting a reliability evaluation of the application from a cloud server, and the communication unit is configured to transmit the request for the reliability evaluation and to receive the reliability evaluation result.

9. The terminal of claim 4, further comprising:
a restoration processor to receive terminal backup data and to restore the terminal based on the received terminal backup data.

10. The terminal of claim 4, wherein the backup processing unit generates updated data in response to a change in the data stored in the terminal.

11. A cloud server, comprising:
a backup processing unit to receive backup data from a terminal;
a virtual device processing unit to generate a virtual device corresponding to the backup data;
a reliability evaluator to evaluate reliability of an application in response to a request from the terminal; and
a virtual interface to receive an operation call and to execute the application in the virtual device.

12. The cloud server of claim 11, further comprising:
a reliability database to store reference information;
a reference information generator to generate reference information; and
a reference information database to store generated reference information,
wherein the reliability evaluator determines the reliability of the application based on the reference information.

13. The cloud server of claim 11, further comprising:
a recovery processing unit to transmit the backup data to the terminal in response to a request for backup data from the terminal.

14. The cloud server of claim 11, wherein the virtual interface executes the application in the virtual device if the reliability evaluator determines the application is unreliable.

15. A method for executing an application in a virtual device, comprising:
generating the virtual device in a cloud server;
receiving an operation call to the virtual device in the cloud server, the operation call corresponding to an application;
executing the operation included in the operation call in the virtual device;
determining if an execution result of the operation is generated; and
if the execution result is generated, transmitting the execution result to the terminal.

16. The method of claim 15, wherein generating the virtual device comprises:
receiving backup data from the terminal;
generating a virtual device based on the backup data;
determining if update data is received;
if update data is received, applying the update data to the virtual device.

17. The method of claim 15, wherein the operation call is a remote method invocation scheme.

18. A method for executing an application in a terminal, comprising:
generating backup data corresponding to data stored in the terminal;
transmitting the backup data to a cloud server, the backup data for generating a virtual device in the cloud server;
downloading an application in the terminal;
evaluating reliability of the application in the terminal;
if the application is considered reliable, executing the application; and
if the application is not considered reliable:
storing the application in an unreliable application region of the terminal;
altering a code of the application to generate an operation call to the virtual device;
requesting a reliability evaluation of the application from a cloud server;
receiving a result of the reliability evaluation; and
if the reliability evaluation determines the application is reliable, executing the application in the terminal.

19. The method of claim 18, further comprising:
in response to a restoration event:
in the terminal, requesting the cloud server for the backup data;
in the terminal, receiving backup data; and
in the terminal, restoring the terminal using the received backup data.
